(19) United States
(12) Patent Application Publication
(10) Pub. No.: US 2019/0340537 A1
(43) Pub. Date: Nov. 7, 2019

(54) Personalized Match Score For Places

(71) Applicant: Google LLC, Mountain View, CA (US)

(72) Inventors: Simon Fung, San Francisco, CA (US); Dana Wilkinson, Mountain View, CA (US); Michael Peter Mattiacci, Sunnyvale, CA (US); Sarah Sachs, San Francisco, CA (US); Tong Wang, San Francisco, CA (US); David Chen, San Francisco, CA (US); Marcel Uekermann, San Francisco, CA (US); Chandrasekhar Thota, Saratoga, CA (US); Matthew Burgess, San Francisco, CA (US)

(21) Appl. No.: 16/404,148

(22) Filed: May 6, 2019

Related U.S. Application Data
(60) Provisional application No. 62/667,952, filed on May 7, 2018.

(51) Int. Cl. G06N 20/00; G06Q 30/02; G06K 9/62; G06F 17/18

(52) U.S. Cl. CPC G06N 20/00; G06F 17/18; G06K 9/6267; G06Q 30/0282

(57) ABSTRACT

A personalized score for a place that a user may want to visit is computed and displayed to the user. The score is computed based on at least one of inferred or explicit parameters, using machine learning. The score may be displayed to the user in connection with the place, and in some examples explanations of the underlying factors that resulted in the score are also displayed. Because each user is unique, the score may be different for one person than for another. Accordingly, when a group of friends are deciding on a place to visit, such as a place to eat, the personalized score for a given restaurant may be higher for a first user than for a second user.

### CROSS-REFERENCE TO RELATED APPLICATIONS

The present application claims the benefit of the filing date of U.S. Provisional Patent Application No. 62/667,952 filed May 7, 2018, the disclosure of which is hereby incorporated herein by reference.

### BACKGROUND

When deciding which place to visit, such as dining out, finding things to do on a weekend, going shopping, etc., users use various information to help them make a decision. They may look at ratings and reviews of a place, consult their friends or family, or rely on third party rankings to formulate an opinion of a place. This process can be lengthy and time-consuming as this information is meant to be consumed by everyone, and opinions vary from one person to the next. A user may look at a rating or a review and wonder if the reviewer has similar taste to them or cares about the same things.

### BRIEF SUMMARY

According to the present disclosure, a personalized score is provided for a place that the user may want to visit. The score is computed based on at least one of inferred or explicit parameters, using machine learning. The score may be displayed to the user in connection with the place, and in some examples the user may also view the underlying factors that resulted in the score. Because each user is unique, the score may be different for one person than for another. Accordingly, when a group of friends are deciding on a place to visit, such as a place to eat, the personalized score for a given restaurant may be higher for a first user than for a second user.

In addition to providing personalized scores, the systems and methods described herein provide a complete view of all the places the user might want to know about. Thus, for example, the user may look at any arbitrary place (e.g., a place they heard about from someone else, read about in an article, saw in an ad, etc.) and understand whether the place matches them well. This becomes more important when trying to make a joint decision with multiple people. Each individual user may want to know if a place would be ok for them, even though it's not the best match for them. Each user may also want to know if a place is a bad match for them, or if it violates one of their restrictions.

One aspect of the disclosure provides a method for providing a personal score for a place. The method includes identifying, with one or more processors, one or more places of potential interest to a user, identifying, with the one or more processors, user preferences, determining, with the one or more processors, a personal score for one or more of the places, the personal score being generated based on the identified user preferences, and providing for display, with the one or more processors, the personal score for the one or more of the places in association with information about the place. According to some examples, the method may further include receiving a request, matching the one or more places of potential interest to the request, and sorting the places matching the request based on the personal scores. The user preferences may include implicit preferences inferred by information passively collected from the user with the user's authorization and/or explicit preferences entered by the user through a user interface. Determining the personal score may include applying a machine learning model. According to some examples, a set of explanations may also be generated and provided for display, wherein the set of explanations indicate reasons the user may like the one or more places.

Another aspect of the disclosure provides a system for providing a personal score for a place, including one or more memories storing preferences of the user, and one or more processors in communication with the one or more memories. The one or more processors may be configured to receive a request for a place, identify one or more places matching the request, identify user preferences, determine a personal score for one or more of the place matching the request, the personal score being generated based on the identified user preferences, and provide for display the personal score for the one or more of the place matching the request in association with information about the place matching the request.

Yet another aspect of the disclosure provides a method for constructing a machine learning model to generate a personal score for a place, the personal score based on preferences of a given user. The method may include accessing data from multiple sources, generating, using the accessed data, a user table including user visit data and online place interactions, generating, using the accessed data, a place table including an identification of places matching a particular set of criteria and place-level attributes used for identifying preferences, creating a lookup table associating a user identifier to samples of places, the samples being places for which the user has indicated interest or disinterest, joining the lookup table to the user table, and training a model to predict a personal score for any given place using the joined tables. According to some examples, the method may further include computing a personal score using the model, receiving survey results relating to an accuracy of the computed personal score, and modifying the model based on the survey results.

### BRIEF DESCRIPTION OF THE DRAWINGS

FIG. 1 illustrates an example interface according to aspects of the disclosure.

FIG. 2 is a block diagram illustrating an example system according to aspects of the disclosure.

FIG. 3 illustrates another example interface according to aspects of the disclosure.

FIG. 4 illustrates an example of information used to compute a personalized score according to aspects of the disclosure.

FIG. 5 illustrates example explanations according to aspects of the disclosure.

FIG. 6 illustrates another example of explanations according to aspects of the disclosure.

FIG. 7 is a flow diagram illustrating an example machine learning method according to aspects of the disclosure.

FIG. 8 is a flow diagram illustrating another example machine learning method according to aspects of the disclosure.

FIGS. 9A-C illustrate other example machine learning models according to aspects of the disclosure.

FIG. 10 is a flow diagram illustrating an example method of evaluating a machine learning model according to aspects of the disclosure.

FIG. 11 is an example interface indicating an example score according to aspects of the disclosure.

FIG. 12 is another example interface according to aspects of the disclosure.

FIGS. 13A-C illustrate example interfaces for editing preferences according to aspects of the disclosure.

FIG. 14 illustrates an example relationship between a place detail page and a score detail page, according to aspects of the disclosure.

FIG. 15 illustrates an example relationship between the score detail page and the preference editing section, according to aspects of the disclosure.

FIG. 16 illustrates an example interface for obtaining information according to aspects of the disclosure.

FIG. 17 illustrates example manipulations of the interface of FIG. 16.

FIG. 18 illustrates an example expansion of an interface according to aspects of the disclosure.

FIG. 19 illustrates an example interface requesting feedback and manipulation of the interface according to aspects of the disclosure.

FIG. 20 is another example illustrating manipulation of the example interface requesting feedback according to aspects of the disclosure.

FIG. 21 illustrates an example survey according to aspects of the disclosure.

FIG. 22 illustrates another example survey according to aspects of the disclosure.

FIG. 23 is a flow diagram illustrating an example method of providing a personal score for a place, according to aspects of the disclosure.

### DETAILED DESCRIPTION

### Overview

The systems and methods described herein predict how well a place matches a users' tastes and preferences. The user's personal preferences are inferred using implicit signals. In some examples, explicit preferences are also collected directly from the users. These user preferences are then matched against the details of a place using a trained machine learning model to predict how well a place matches a user's taste in the form of a score. This score, as well as explanations for why the score is high or low, is provided to the user. The explanations may include, for example, that the place matched a preference the user liked or matched a preference the user disliked.

As just one example, the place for which the user is searching may be a restaurant. A profile for the user may be generated, and various parts of the profile may be computed. These various parts may include attributes like dietary restrictions, cuisine preferences, ambiance preferences, budget sensitivity, etc. The profile may also include any interactions the user may have had with a place, including but not limited to the users' location and web/search history, whether the user saved or bookmarked a place, if they called or navigated to the place, as well as any reviews, ratings, or photos uploaded for the place. Such information may be used to infer places the user likes or visited often.

Client computing devices which are used for collecting implicit signals each have a privacy setting, which must be set to authorize such reporting. For example, the user of the client computing devices has an option to turn such reporting on or off, and may have an option to select which types of information are reported and which types are not. By way of example only, the user may allow reporting of particular locations visited, but not all locations. Moreover, privacy protections are provided for any data transmitted by the mobile device, including, for example, anonymization of personally identifiable information, aggregation of data, filtering of sensitive information, encryption, hashing or filtering of sensitive information to remove personal attributes, time limitations on storage of information, or limitations on data use or sharing. Rather than using any personal information to uniquely identify a mobile device, a cryptographic hash of a unique identifier may be used.

For many of the attributes that are inferred, a mechanism is provided for users to provide, confirm, change, or delete the specific preference. The values can be ‘like’, ‘dislike’, ‘neutral’, ‘must have’, ‘must not have’, etc. depending on the attribute. Profiles may also be computed for each place to describe what type of place it is. For example, each restaurant may have a profile that describes it by the type of cuisine served, whether it caters to specific diets, or specific dishes it may have. The restaurant profile may also include information about its ambiance, how similar it is to another restaurant, price level, etc. A list of exemplars may be generated for the user's most favorites places based on visits, the user's ratings/reviews of a place, saving the place to their favorite's list, etc. This can be further extended to build a comprehensive user-place graph that indicates a user's affinity to each place the user has interacted with in the past. These place affinities can be used to further determine how likely a user will enjoy visiting a similar place. Place similarities can be based on similarities between the place profiles (e.g. similar menus, price, ratings, ambience, descriptions, reviews, etc.), or using collaborative filtering techniques to determine if similar types of users visit both places.

While the examples above relate to restaurants, it should be understood that personalized scores may be generated for any number of different types of places. For example, the scores may be generated for stores (e.g., clothing stores, grocery stores, electronic stores, etc.), hotels, attractions (e.g., museums, amusement parks, etc.), events (e.g., concerts, sporting events, street fairs, etc.), gas stations, or any other points of interest. Scores may also be generated for more general areas including many points of interest, such as for particular cities, malls, etc.

A machine learning (ML) model is trained to predict how much a user would like a place. The labels can be collected explicitly through survey questions, in-app feedback mechanisms, or other rating flows where we ask users directly how much they like a place. The labels can also be based on other proxy signals like place visits (Location history) or place clicks (Web/Search history.) Each training example consist of a single label which may be survey response, rating, visit, or click, etc. The input features to the ML model includes all the implicit and explicit user preferences described above. They also include details about the place, as described above. The output of the model includes a score that indicates the user's affinity to a place and how well the place matches the user's personal preferences, as well as explanations for which specific features contributed the most to the final score. For example, a place would receive a high score if the user is vegetarian and the restaurant is popular among vegetarians. Conversely, a steakhouse would receive a low score for a vegetarian user.

The advantage of solving the problem in this manner is allowing a wide range of users to benefit from the recommendation model. A user may passively provide information by authorizing reporting of their location and/or search history. The user's preferences or places they like can then be automatically inferred by observing what places they visit, click on, or get directions to. On the other hand, a user who does not authorize reporting of their history can still explicitly provide their preferences by setting their preference values, and by providing direct feedback about whether they like a place or not (e.g. ratings, reviews, starring, etc.). In addition to inferring the score, a list of personalized justifications is provided for why the user might like or dislike a place. These may be directly related to the user profile, such as “Because you like <cuisine X>” or “Similar to <place Y that the user likes>”, or they could be combined with other sources of information to make the justification more colorful, such as top lists like “Top 10 places in SF for <cuisine X>” if the user likes <cuisine X>. Such top lists could come from third-party publications or they can be generated algorithmically. These justifications will help users in understanding the reasons for which a place is recommended. They also provide the user with the option to update their profile if the inference is incorrect or their preferences have changed.

The personalized scoring system and methods may be implemented in any of a number of applications, such as search applications, map/navigation applications, scheduling applications, dining/shopping applications, etc. For example, the score will show when a user makes a categorical query (e.g. “restaurants near me”), or if they search for a specific place. The score may be shown next to other place details like user ratings, number of reviews, price info, etc. The user may also be able to click on the score to get a detail page explaining how the score was computed (e.g. the list of justifications). In other examples, such as in map applications, the score may be shown in the map itself, next to the place markers. In addition to just displaying this score, places may be ranked by this score for recommendation purposes. For example, when providing a listing responsive to the search for “restaurants near me,” places with higher personalized scores may be ranked higher.

In addition to the foregoing example implementations, the system and method may be used to send recommendations to users for any of a number of applications or other products, now known or future developed. The scores may be used in conjunction with other business logic for deciding when recommendations should be made. These scores could also be used to decide which point of interests to show to the user on a map, such as by surfacing the points of interest the user is most likely going to visit on the map view. The score could also be used for personalizing operation of an electronic assistant device. For example, the assistant device can recommend a restaurant to visit or for food ordering, or it can recommend things to do on a weekend, such as visit a park, take a pottery class, etc. The assistant can also make recommendations for helping the user explore a new area, such as “check out the local hiking trail,” or “visit the local favorite bar.” It should be understood that these are merely examples of numerous possible implementations, and should not be considered as limiting.

### Example Systems

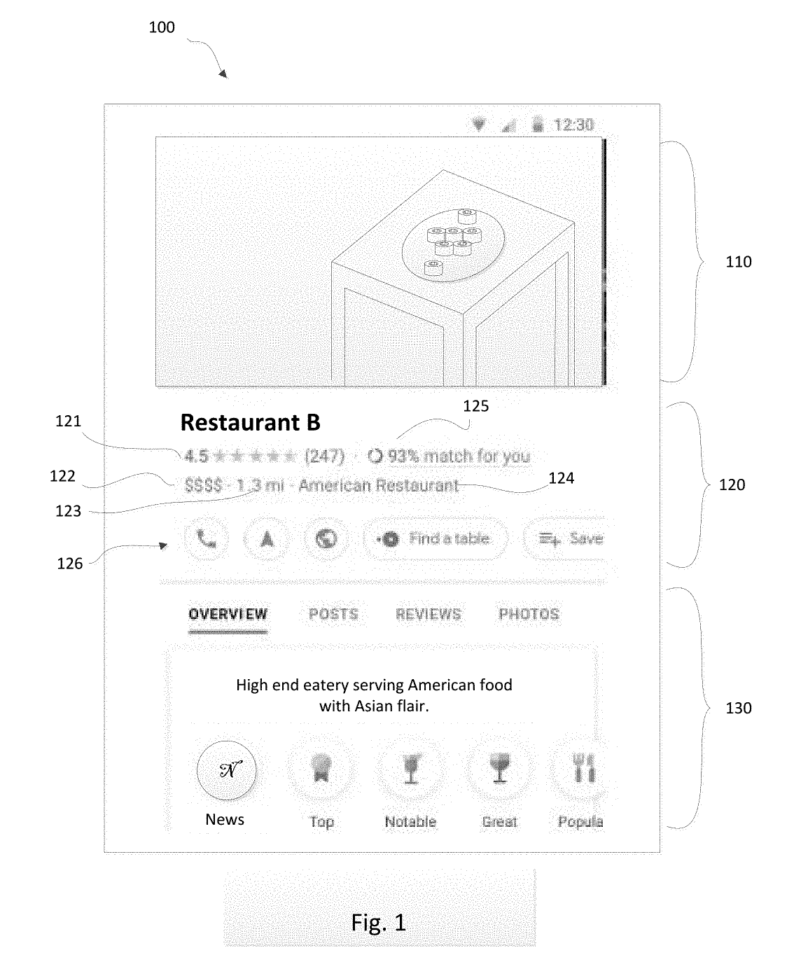

FIG. 1 illustrates an example display of the personal score for a given place. In this example, graphic 100 includes an image section 110, a summary information section 120, and a detailed information section 130. The graphic 100 may be displayed, for example on a client device, in response to a request for information related to Business A. The request for information may include, for example, an address, business name, general geographical area, type of business, etc. For example, a user may have submitted a search for a restaurant, and selected a search result corresponding to Restaurant B. While Restaurant B has been rated as having 4.5 stars by 247 reviewers in the general population, such information is not particularly tailored to the user. A personal score 125, in this example 93%, is also provided. As discussed in further detail below, the personal score 125 may be based on explicit and/or implicit preferences of the user. Such score may give a better indication to the user whether the user is likely to enjoy the Restaurant B.

Image section 110 may include an image relevant to the place. For example, for Restaurant B the image may be of the inside or outside of the restaurant, a particular dish served at the restaurant, etc.

Summary information section 120 may include a variety of information describing the place. By way of example only, for Restaurant B such information includes a rating 121, a price category 122, a distance 123 from a particular location (e.g., the user's location), a categorization 124 of the type of food served, and the personal score 125. The summary section 120 may also include one or more links 126, facilitating actions by the user in connection with the place. For example, the links 126 may enable the user to call the place, get directions to the place, visit a website of the place, reserve a table at the place, save the place to one or more personal lists, etc. The foregoing are merely examples, and it should be understood that the summary information section 120 may include any of a number of other types of information. For example, the summary information section 120 may also include text, such as a listing of the operating hours of the Restaurant B.

Detailed information section 130 may include further information related to the place. In some examples, such information may correspond to information in the summary section 120. For example, reviews of the place which correspond to the rating 121 may be provided. Other examples of detailed information include descriptions, photos, and mentions of the place in other media, such as news or third party rankings.

While a number of example sections are described above in connection with FIG. 1, and the personal score 125 is shown as being displayed as a percentage, it should be understood that these are merely examples. The personal score 125 may be provided for display in any of a number of ways, such as text, pictorial diagrams, charts, graphs, etc. As described in further detail herein, the personal score 125 may also include a link to further information related to the personal score 125. For example, the further information may explain the information used to determine the score, and allow the user to update the information used. In some examples, the personal score 125 may be provided to other applications, such as scheduling applications, communication applications, etc.

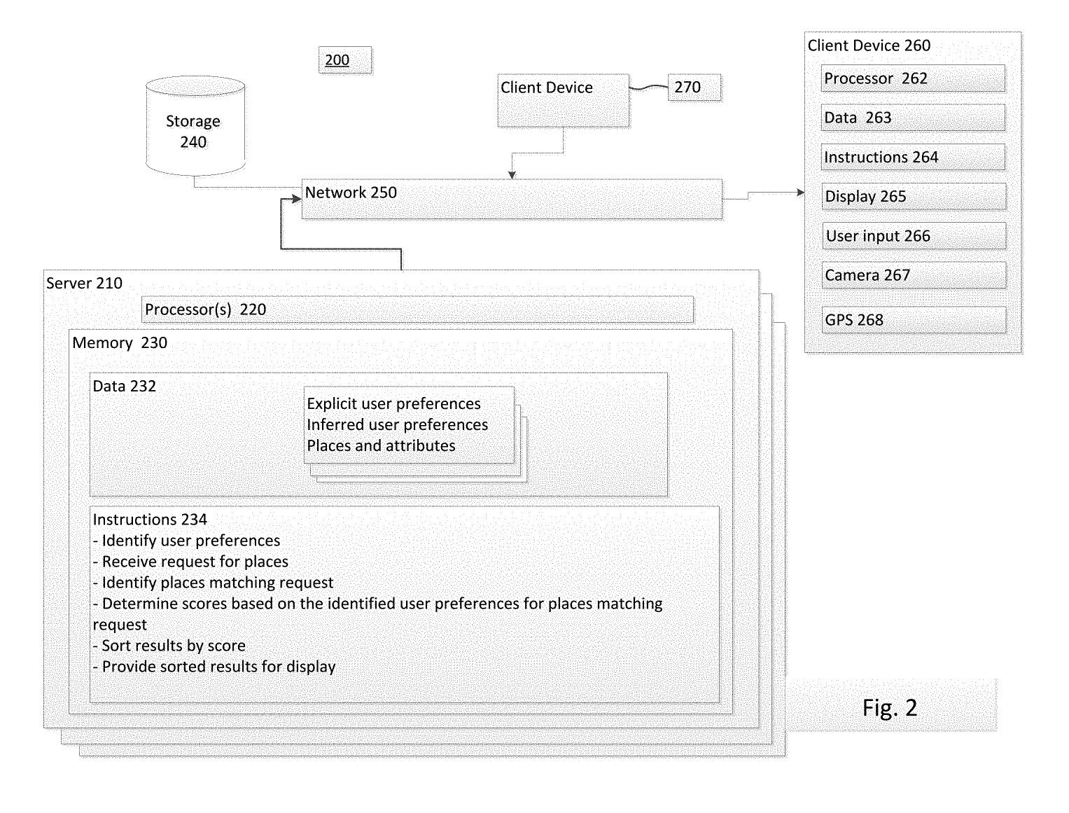

FIG. 2 illustrates an example system used to compute personal scores for places. It should not be considered as limiting the scope of the disclosure or usefulness of the features described herein. In this example, system 200 can include computing devices 210 in communication with one or more client devices 260, 270, as well as storage system 240, through network 250. Each computing device 210 can contain one or more processors 220, memory 230 and other components typically present in general purpose computing devices. Memory 230 of each of computing device 210 can store information accessible by the one or more processors 220, including instructions 234 that can be executed by the one or more processors 220.

Memory 230 can also include data 232 that can be retrieved, manipulated or stored by the processor. The memory can be of any non-transitory type capable of storing information accessible by the processor, such as a hard-drive, memory card, ROM, RAM, DVD, CD-ROM, write-capable, and read-only memories.

The instructions 234 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance. Functions, methods, and routines of the instructions are explained in more detail below.

Data 232 may be retrieved, stored or modified by the one or more processors 220 in accordance with the instructions 234. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 220 can be any conventional processors, such as a commercially available CPU. Alternatively, the processors can be dedicated components such as an application specific integrated circuit (“ASIC”) or other hardware-based processor. Although not necessary, one or more of computing devices 210 may include specialized hardware components to perform specific computing processes, such as decoding video, matching video frames with images, distorting videos, encoding distorted videos, etc. faster or more efficiently.

Although FIG. 2 functionally illustrates the processor, memory, and other elements of computing device 210 as being within the same block, the processor, computer, computing device, or memory can actually comprise multiple processors, computers, computing devices, or memories that may or may not be stored within the same physical housing. For example, the memory can be a hard drive or other storage media located in housings different from that of the computing devices 210. Accordingly, references to a processor, computer, computing device, or memory will be understood to include references to a collection of processors, computers, computing devices, or memories that may or may not operate in parallel. For example, the computing devices 210 may include server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over network 260.

Each of the computing devices 210, 260, 270 can be at different nodes of a network 250 and capable of directly and indirectly communicating with other nodes of network 250. Although only a few computing devices are depicted in FIG. 2, it should be appreciated that a typical system can include a large number of connected computing devices, with each different computing device being at a different node of the network 250. The network 250 and intervening nodes described herein can be interconnected using various protocols and systems, such that the network can be part of the Internet, World Wide Web, specific intranets, wide area networks, or local networks. The network can utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each of the computing devices 210 may include web servers capable of communicating with storage system 240 as well as computing devices 260, 270 via the network 250. For example, one or more of server computing devices 210 may use network 250 to transmit and present information to a user on a display, such as display 265 of computing device 260. In this regard, computing devices 260, 270 may be considered client computing devices and may perform all or some of the features described herein.

Each of the client computing devices 260, 270 may be configured similarly to the server computing devices 210, with one or more processors, memory and instructions as described above. Each client computing device 260, 270 may be a personal computing device intended for use by a user, and have all of the components normally used in connection with a personal computing device such as a central processing unit (CPU), memory (e.g., RAM and internal hard drives) storing data and instructions, a display such as display 265 (e.g., a monitor having a screen, a touch-screen, a projector, a television, or other device that is operable to display information), and user input device 266 (e.g., a mouse, keyboard, touch-screen, or microphone). The client computing device may also include a camera 267 for recording video streams and/or capturing images, speakers, a network interface device, and all of the components used for connecting these elements to one another. The client computing device 260 may also include a location determination system, such as a GPS 268. Other examples of location determination systems may determine location based on wireless access signal strength, images of geographic objects such as landmarks, semantic indicators such as light or noise level, etc.

Although the client computing devices 260, 270 may each comprise a full-sized personal computing device, they may alternatively comprise mobile computing devices capable of wirelessly exchanging data with a server over a network such as the Internet. By way of example only, client computing device 260 may be a mobile phone or a device such as a wireless-enabled PDA, a tablet PC, a netbook, a smart watch, a head-mounted computing system, or any other device that is capable of obtaining information via the Internet. As an example the user may input information using a small keyboard, a keypad, microphone, using visual signals with a camera, or a touch screen.

As with memory 230, storage system 240 can be any type of computerized storage capable of storing information accessible by the server computing devices 210, such as a hard-drive, memory card, ROM, RAM, DVD, CD-ROM, write-capable, and read-only memories. In addition, storage system 240 may include a distributed storage system where data is stored on a plurality of different storage devices which may be physically located at the same or different geographic locations. Storage system 240 may be connected to the computing devices via the network 250 as shown in FIG. 2 and/or may be directly connected to any of the computing devices 210.

Storage system 240 may store data, such as maps, information associated with different places, user preferences, etc. Using the stored data, the computing devices 110 may determine personal scores for places, the personal score being tailored to each user.

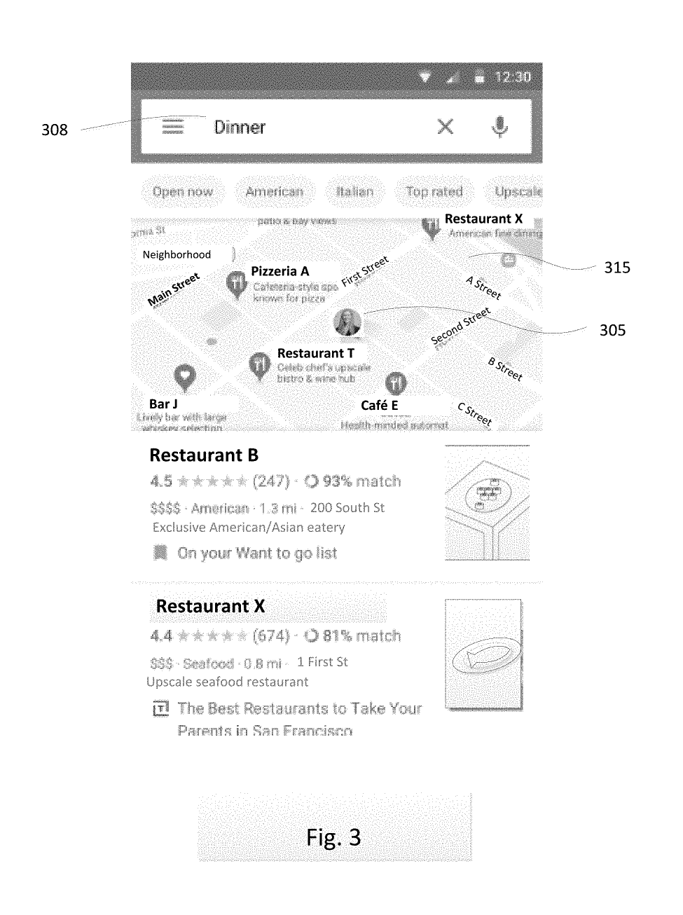

FIG. 3 illustrates an example of providing personal scores for a plurality of search results. User 305 enters a search 308, in this example “dinner.” As the user 305 has provided her location, either explicitly or by authorizing location sharing on her client device, the user's location may be represented on map 315. The map 315 may also include a depiction of geographical objects at the particular geographic location surrounding the user 305. For example, the geographic objects may include roads, buildings, landmarks, statues, street signs, etc. The objects may be depicted in, for example, a roadgraph, aerial imagery, street level imagery, or the like.

Places responsive to the user's search, such as places serving dinner within a predetermined geographical range of the user's location, are identified. The search results may also be represented on the map 315, such as by marker points. Though not shown in FIG. 3, the representations of the search results in the map 315 may also include the personal scores. For example, the personal scores may be represented by percentages or other numbers on or near the marker points. In other examples, the personal scores may be represented by varying a size, shape, shading, or other aspect of the marker or map. It should be understood that these are merely examples, and any of a number of indicators may be used.

As shown, the search results may also be listed below the map, and the listing includes the personal scores. In this particular example, the results are shown as listed in order of highest personal score. Restaurant B most closely matches the explicit and/or implicit preferences of the user 305, and thus is listed at the top with a high personal score of 93%. A next closest match to the user's preferences is Restaurant X, with a personal score of 81%. Further matches, with descending scores, may be listed below Restaurant X and may be viewed by scrolling or the like.

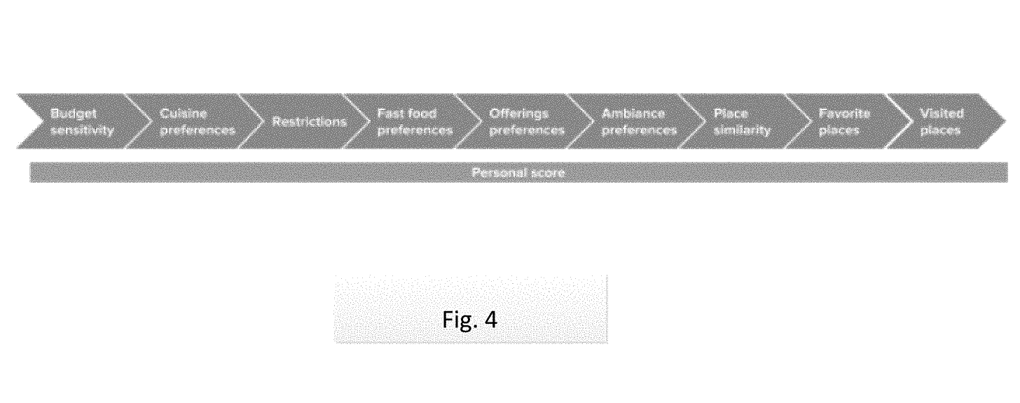

FIG. 4 provides an example of different parameters that may be used to determine a personal score for a restaurant. As shown, such parameters include a number of different types of preferences, such as budget, cuisine, fast food, offerings, ambiance, etc. The parameters may also include restrictions. Just as one possible example, a restriction may be that the user has a nut allergy. Accordingly, a restaurant that puts a bowl of peanuts on each table and encourages patrons to throw the shells on the floor would violate the user's restriction. Such restaurant may receive a very low score, or be excluded from the search results altogether. Other parameters may be comparative to the user's history. For example, such parameters may include place similarity, favorite places, visited places etc. If a given restaurant is highly similar to one or more other restaurants the user has visited or has indicated to be a favorite, the given restaurant will receive a higher personal score for the user.

While a number of example parameters are shown in FIG. 4, it should be understood that a number of other parameters are possible. Moreover, the different types of parameters may be modified based on the type of place being searched. For example, an attraction (museum, playground, etc.), service (e.g., car wash, salon, etc.), or other type of point of interest would have different parameters relative to features of that place.

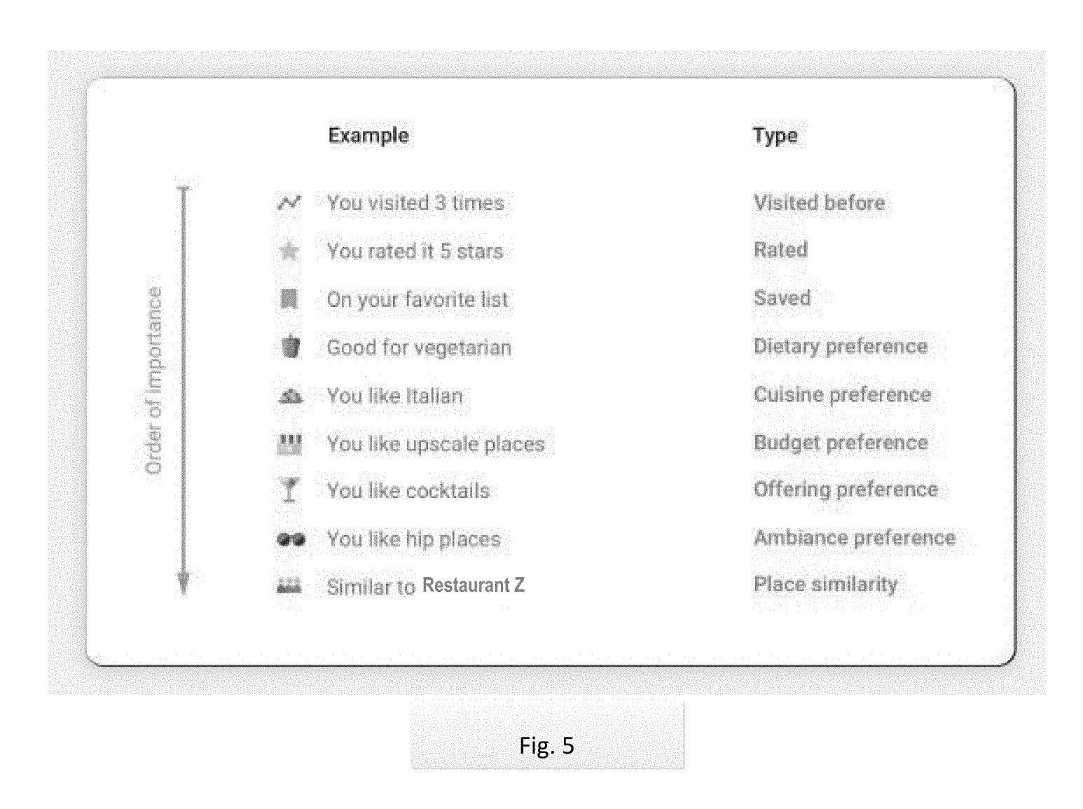

FIG. 5 provides examples of the different types of parameters shown in FIG. 4, and further provides an example of how such preferences may be presented to the user. Each example in the left column is listed in association with the type of preference in the right column. In this example, the preferences are ranked by order of importance. While in some examples a default order of importance may be used, in other examples the user may modify the order of importance based on the user's particular concerns. In further examples, the order of importance may be determined based on the user's implicit preferences. For example, if the user only visits upscale places, but those places vary by the type of cuisine offered, then budgetary preference may take precedence over cuisine preference.

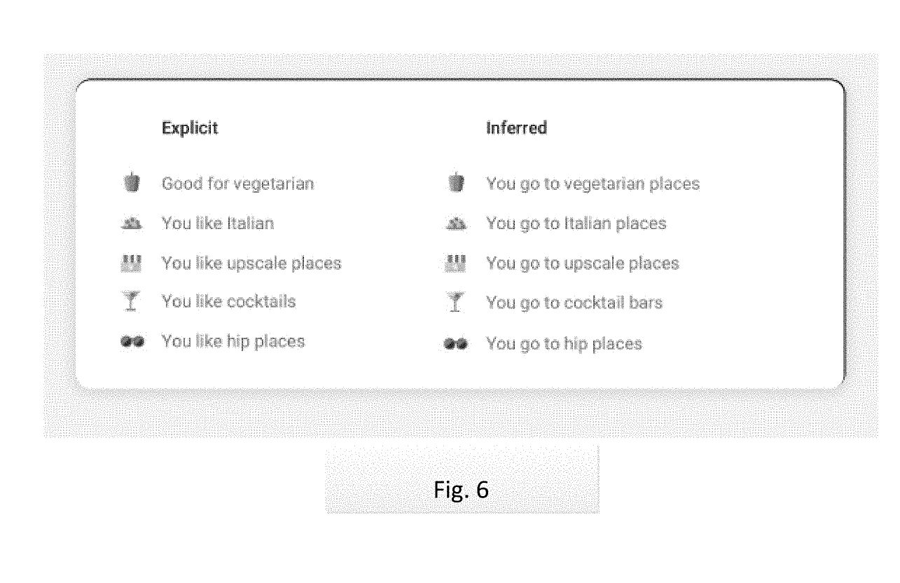

FIG. 6 provides an example of explicit preferences as compared to inferred preferences. For example, a user may explicitly indicate, such as through a user interface, that the user is a vegetarian and that the user likes Italian cuisine. The same information may be inferred if the user typically visits vegetarian places and Italian restaurants.

According to some examples, a combined personal score may be generated for two or more users. For example, two friends may be interested in meeting at a restaurant for dinner, but the friends may have different personal preferences. As such, a restaurant that has a high personal score for one user may have a low personal score for the other user. To accommodate the two friends, a combined personal score may take into account factors based on both users' preferences, both positive and negative. For example, a first user may identify a second user by information associated with an account of the second user. Such information may include, for example, a unique identifier, an email address, a username, or any other unique information. Once the first and second user are identified, a combined personal score may be generated. The combined personal score may be provided alongside other information, such as individual personal score for the first and/or second users. The combined personal score may be provided through any of a number of applications, such as a communication application that connects the first user and the second user.

### Machine Learning:

The personal score may be computed using machine learning. According to some examples, the process is split into different phases, including feature extraction, training example generation, model training and evaluation.

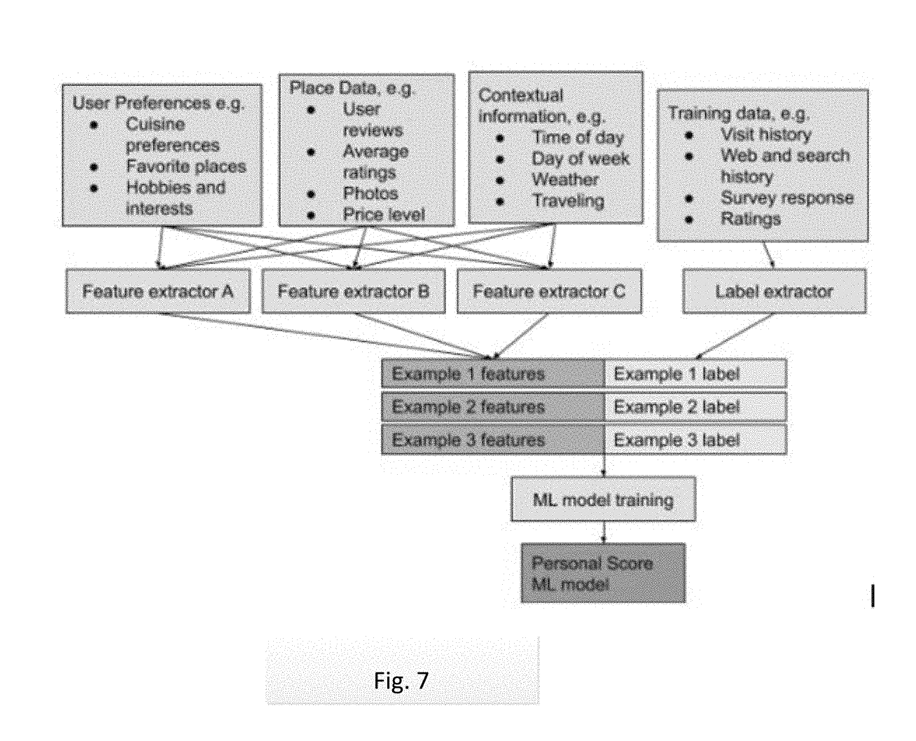

FIG. 7 illustrates an example of how a personal score machine learning model is trained. Each training example consists of a (user, place) pair, optional context information, and a corresponding label. First, various user, place, and context data are joined together and a set of feature extractors are applied to the joined data to generate the relevant machine learning features. Similarly, a label extractor is applied to the corresponding training data source to generate the necessary label for the example.

As mentioned previously, the user, place, context and training data can come from various sources. User data may include inferred and explicit user preferences, their visited places, ratings and reviews they have posted, places they have bookmarked or saved, etc. Place data may include average star ratings, reviews from the general public, photos of the place, webpages mentioning the place, price level, menu items/cuisines served, etc. Context data may include time of day, day of the week, season, weather, if the user is traveling, or if the user is making plans with other people. Finally, training data can come from visit history, web and search activities, survey responses, user's ratings, etc.

The training data used for the model may include both positive and negative factors. Positive factors may include, for example, explicitly answering they like the place in a survey, the number of times the user previously visited the place or similar places, searching for the place, giving a high rating or other factors indicating a user's likely interest in the place. Negative factors may include direct signals like answering they don't like the place in a survey, giving a low rating, or inferred from the fact they never visited or interacted with the place even though it is close to other places the user has visited. It should be understood that other training data may be used in addition or in the alternative to the training data described above.

The set of feature extractors take the joined user/place/context data and outputs a set of machine learning features which could be scalars, category labels, or other suitable values for inputting into a machine learning model. The features could depend solely on user data, solely on place data, or on the combination of all the data. For example, a feature extracted from only user data could be the frequency the user dines out. This indicates a prior on how likely a user would like visiting any restaurant. A feature based solely on place data could be the places' average star rating or number of visitors, indicating the place's general popularity. A feature based on the combination of user and place data could be the user's preference for particular cuisines or menu items served at the place. Another example could be how similar the place is to one of the user's favorite restaurants. Additional context data could further refine the feature to indicate if users have different preferences in different contexts, for example preferring convenient locations when it's raining, or preferring touristy places while traveling.

The label extractor takes the training data and outputs a single label for each example which again could be a scalar, category label, or other suitable values for machine learning models. As an example, the label could be the number of times the user has visited the place, or the label could be the response the user selected when asked how much they like the place in a survey.

Depending on the set of features and labels selected, different machine learning models may be used. Such models may be trained in parallel. Some features may be common across models, while each model may have its own specific features. A shared feature extractor set may be developed. Each model may then select the desired subset of extractors. Similarly, different models may share the same label extractor or use different ones. As an example, the machine learning models may be a linear regression or deep neural network model that predicts how many times a user would visit a place. As another example, the model could be an ordinal regression model that predicts what the user would answer when asked how much they like the place in a survey.

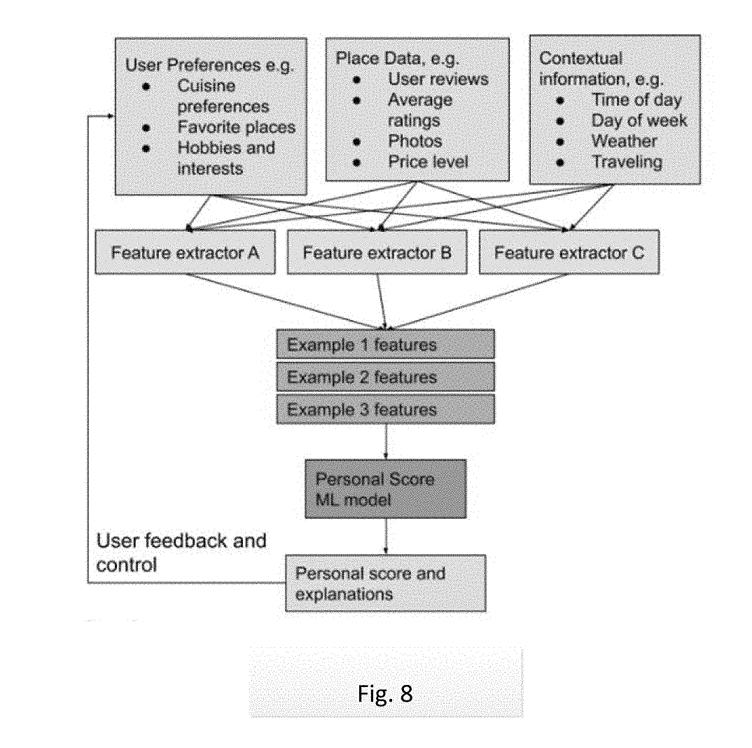

FIG. 8 illustrates an example of how the learned model can be applied. Given a (user, place) pair and optionally contextual information, the model can be used to predict a score that indicates how much the user would like the place. In addition, the model will output a set of explanations for why the user would or would not like the place.

Based on the personal score and explanations shown to the user, the user may provide feedback or use other explicit control to adjust their preferences. This could allow the user to have more fine-grained control over their own data and improve the accuracy of the predicted personal scores.

Signals for the machine learning model may include both personalized and contextual signals, such that the model can intelligently predict what the user would prefer in a particular context. Examples of such signals include cuisine preferences represented as scalar values, similar places, location, weather, time, dietary restrictions, similarity to other saved, visited, or highly rated places, budgetary category, or any of a number of other factors.

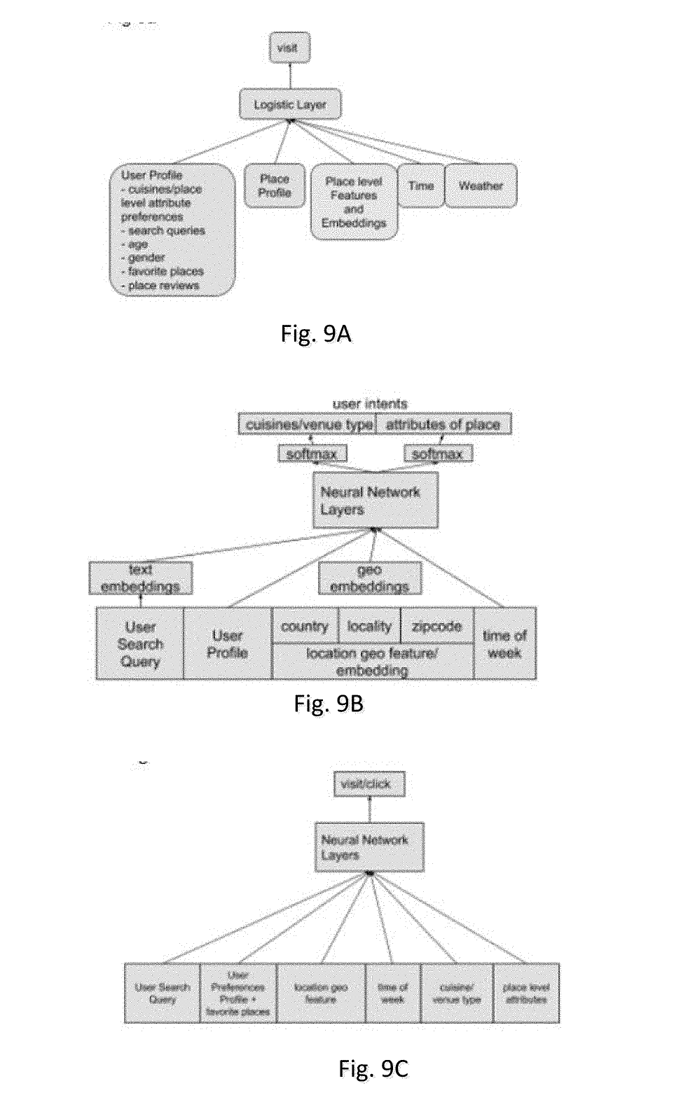

FIG. 9A illustrates an example linear machine learning model. In this model, user, place, and contextual signals are mapped to the binary label of a physical visit. A positive label is extracted directly from user visit history. Negative labels are approximated from the unvisited places near the visited places. The user profile is a vector of unique identifiers for places the user visits more than an average user in the same region. In some example, the model may be enhanced by adding user search queries. The place profile includes the unique identifier and/or unique attribute of the place. Text, such as reviews, key words, etc., can be added as part of a place feature, applying text embedding. Contextual features include location, time and weather. In the linear model, feature crossing may be applied between features, for example, between budget preference and cuisine, between time and other user/place profiles, etc.

FIG. 9B illustrates an example user intent model. This model predicts the user intents in terms of unique identifiers for places and unique attributes. It uses all personalized and contextual signal.

FIG. 9C illustrates an example binary intent model. This model uses intents as features and predicts a binary label for visit or click. This model requires negative labels. Click data may be used as training labels, in which case the negative label is the impression of an intent without a click. Visit data may also be used as training labels, in which case negative sampling methods are applied to create synthetic training labels.

Using one or more of the models, a personal score is generated. By way of example only, the score may be computed using linear regression.

During the training and evaluation phase, the machine learning models may be evaluated using survey and/or user generated data. For example, surveys may be provided to real users to ask their opinions on places recommended by the model, as well as their opinions on personal scores generated for them for the places. User generated data, such as ratings, reviews, lists of the user's saved or favorited places, etc., may also be used by itself or in combination with the surveys.

Evaluation of the machine learning models may focus on various metrics. For example, the evaluation metrics may focus on the ranking of a particular place relative to other places. Additionally or alternatively, the evaluation metrics may focus on the personal score generated for a particular place.

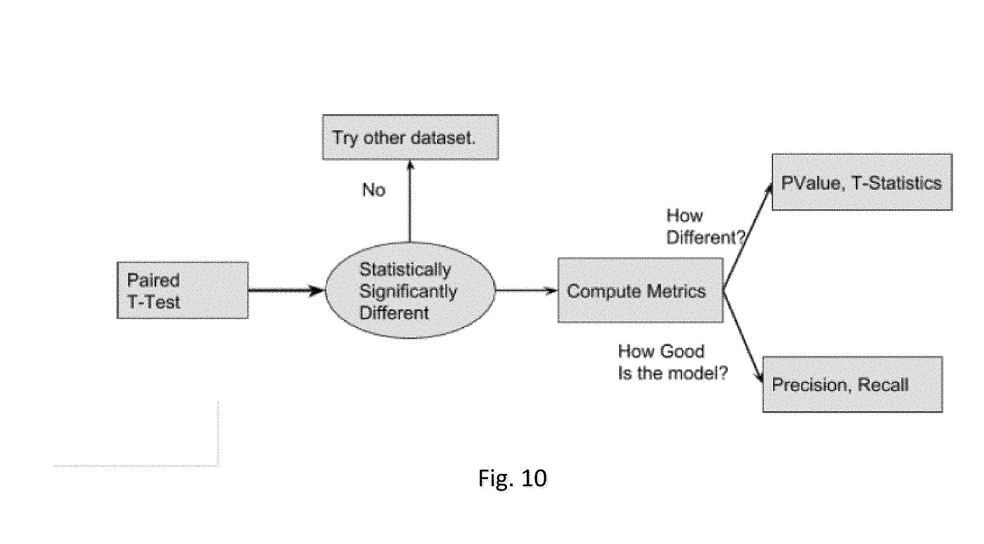

FIG. 10 illustrates an example of how survey data may be used to evaluate the machine learning model. To determine whether the results of one model can be distinguished from another, paired t-tests may be conducted to understand if scores generated by the models differ significantly. Each t-test runs a set of sample data through one of the models. If the scores are not significantly different, another set of sample data may be tried. If the scores are significantly different, other metrics are computed. For example, the other metrics may include precision, recall, accuracy, correlation between personal scores and user responses, and the like.

Results from the machine learning model may also be tuned using, for example, explicit user preferences. For example, as mentioned above, the user may be presented with a personal score for a particular place along with an explanation of the factors that resulted in generation of that personal score. The user may edit one or more factors, for example, by changing budgetary preferences, cuisine preferences, or any of the factors. In such case, an updated score may be generated.

### User Interface:

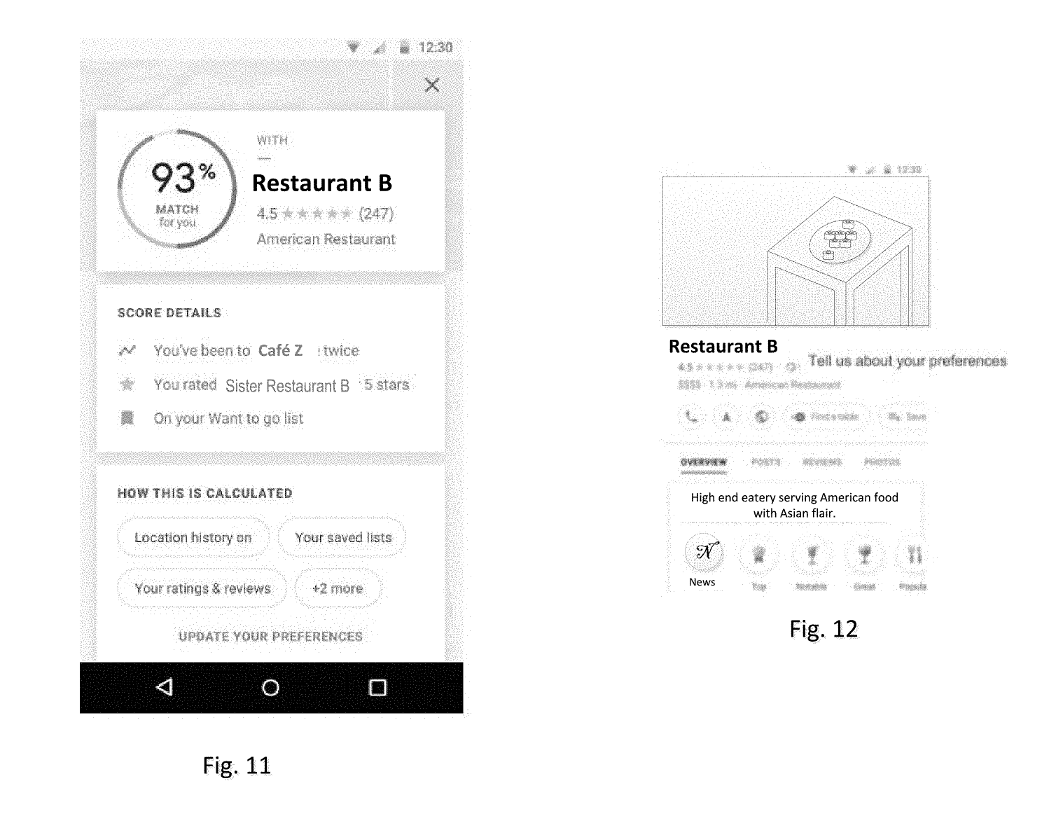

Users may interact with their personal scores, such as to view the underlying factors or to provide explicit preferences, through a user interface. Examples of different aspects of the user interface are provided in FIGS. 11-22.

FIG. 11 provides one example of a possible score detail page, providing information regarding the personal score for the user for a particular place, Restaurant B. In this example, the personal score is provided along with other summary information, such as the name of the restaurant, the type of cuisine offered, and ratings by the general populace.

Moreover, as shown in FIG. 11, score details are also provided. The score details section may list one or more explicit or inferred preferences that results in the score. Such preferences may include all or only a selected few of the preferences used. For example, the score details section may in some examples list only a predetermined number of preferences given the greatest weights in the computation of the personal score. In some examples, this listing of preferences may also include links to update the preferences. For example, the user may click on “On your Want to go list” and be taken to another screen or web page or application showing the user's “Want to go” list.

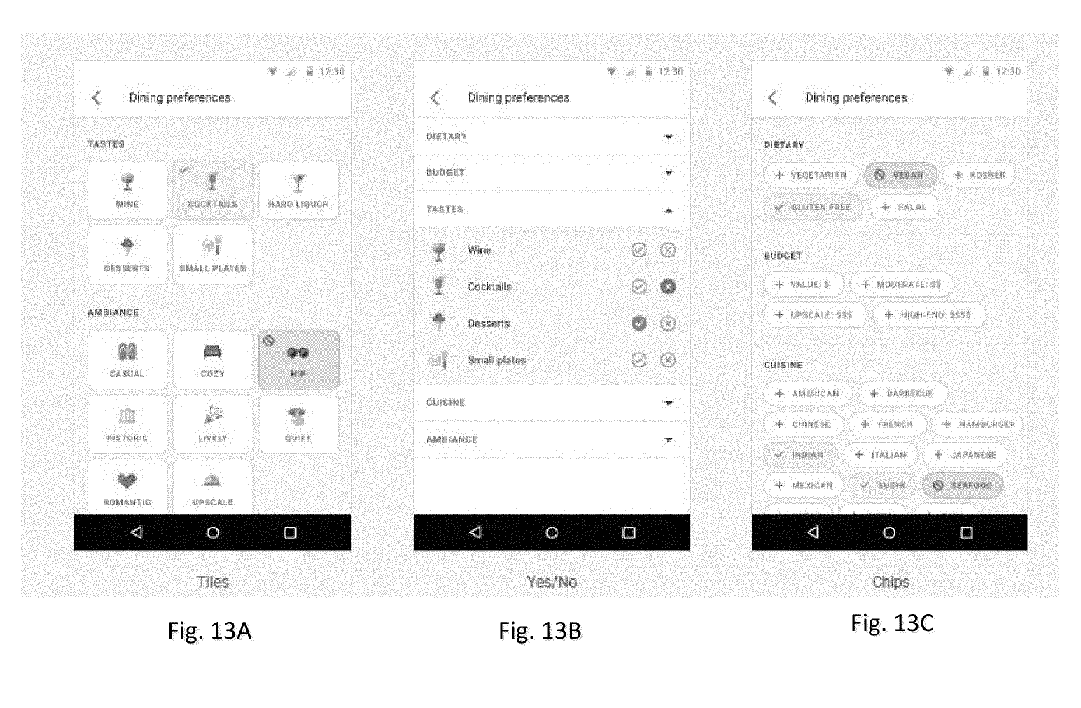

In some examples, a “how is this calculated” section may also be provided. This section may provide an explanation of the different types of information reported and used to compute the personal score. Additionally or alternatively, this section may provide links to edit the user's preferences. For example, individual links may be provided to update discrete information, such as turning location history reporting on or off. A general link, e.g., “Update Your Preferences,” may also be provided to bring the user to a preference editing section, such as those described below in connection with FIGS. 13A-C.

FIG. 12 illustrates an example interface for a place detail page, where a personal score is not generated for lack of information. For example, if the user has not authorized reporting of location or web browsing history, and has not provided any explicit preferences, the machine learning model may not have enough information to compute a score. In such cases, the user may be presented with a prompt, such as a link with text requesting to “tell us about your preferences” or the like. When interacting with the prompt, the user may be taken to the preference editing section.

FIGS. 13A-C provide various examples of the preference editing section. In the example of FIG. 13A, preferences are indicated using tiles. For example, various tiles may be displayed for each of a number of different categories. For restaurants, the categories may include dietary preferences, budget, taste, cuisine, ambiance, or other preferences. Each category may further include one or more options. The options may be represented by various types of graphics. For example, FIG. 13A represents the options using tiles.

Each option may be marked by the user as a positive or negative preference, which may be reflected using a positive or negative indicator. The positive or negative indicator may include any of a number of different representations, such as coloring/shading, graphics (e.g., check mark, “x”, circle with a line through it, etc.), or other representation. As shown in the example of FIG. 13A, the category of tastes includes the options of wine, cocktails, hard liquor, desserts, and small plates. The category of ambiance includes casual, cozy, hip, and others. It should be understood that the categories and options are merely examples, and that any of a variety of different categories and options may be provided. Within the tastes category, the user has indicated a positive preference that he prefers cocktails. Within the ambiance category, the user has indicated a negative preference that he does not like hip places. The user may in some examples indicate more than one positive or negative preference within a category.

FIG. 13B illustrates an example where the options are represented in a list format with radio buttons next to each listing. The user may interact with the radio buttons to indicate a positive or negative preference for the option in the listing.

FIG. 13C illustrates an example where the options are represented using chips. The chips as illustrated are smaller than the tiles of FIG. 13A, such that more chips are visible within a given area. The user may interact with each chip to indicate a positive or negative preference for the option represented by the chip.

While FIGS. 13A-C provide various examples of the user interface for the preference editing section, it should be understood that various alternatives are possible. For example, the options may be represented by any of a number of different types of graphics. In some examples, the user may interact with an option to obtain more detail, such as a description, about the option.

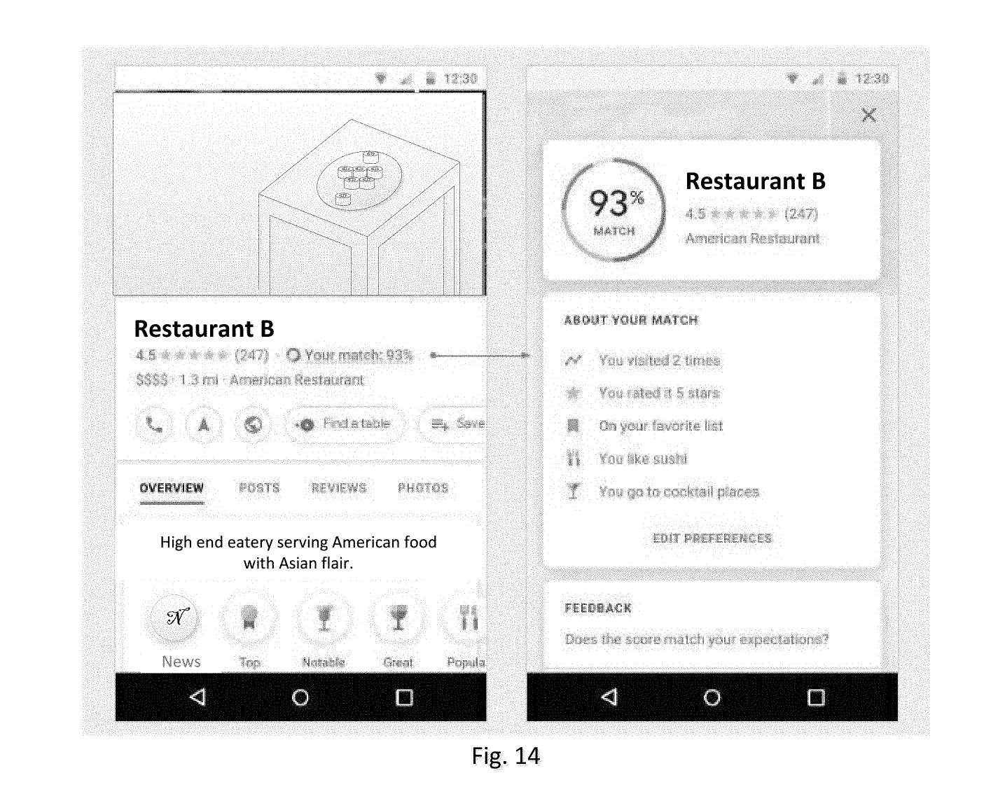

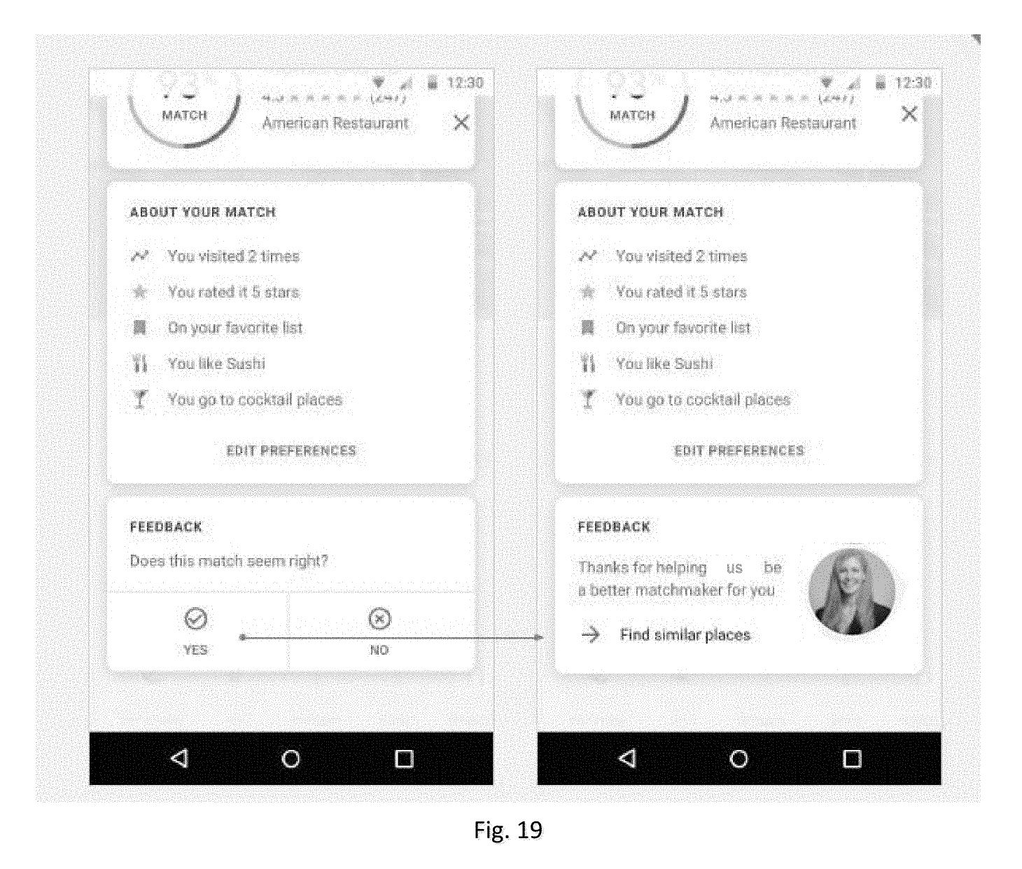

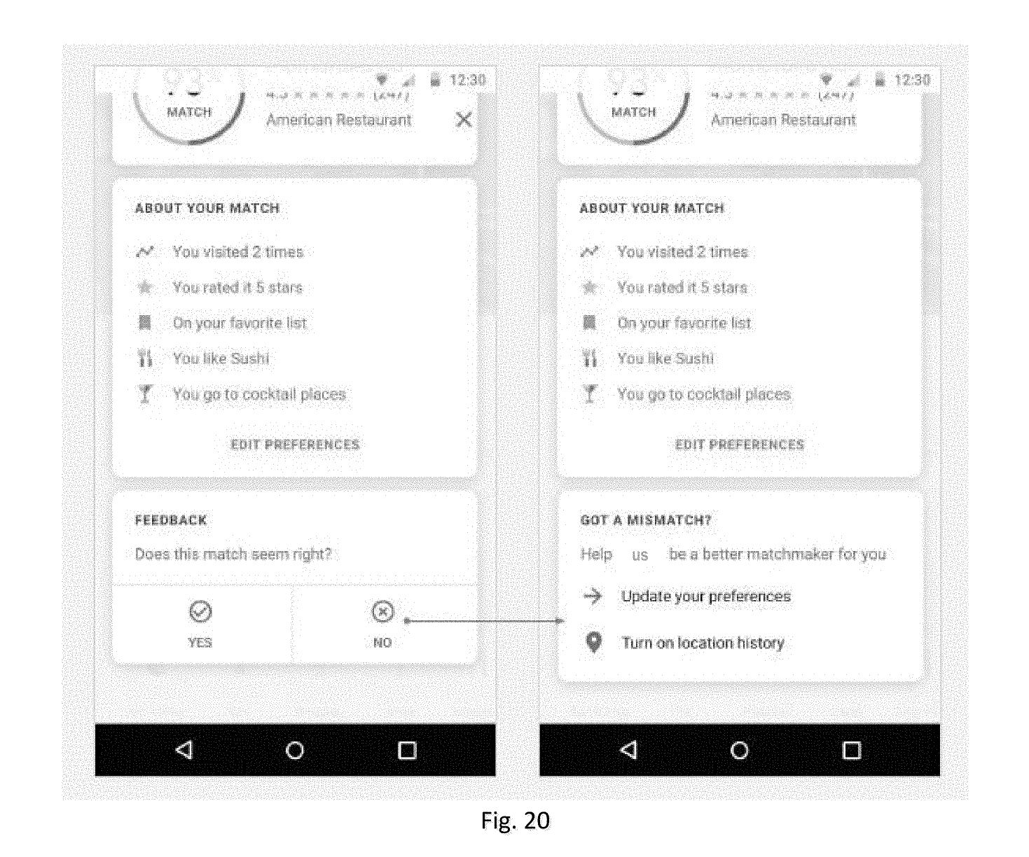

FIG. 14 illustrates an example relationship between a place detail page and a score detail page. An example of the place detail page was described above in connection with FIG. 1. The personal score provided on the place detail page may be a link. When the user interacts with the link, the user may be presented with the score detail page, described in detail above in connection with FIG. 11. In this example, the score detail page also includes a section for user feedback. For example, this section may prompt a user to confirm whether the personal score was accurate based on the user's experience at Restaurant B, or to provide any other type of feedback. Further details of the feedback section are described below in connection with FIGS. 19-20.

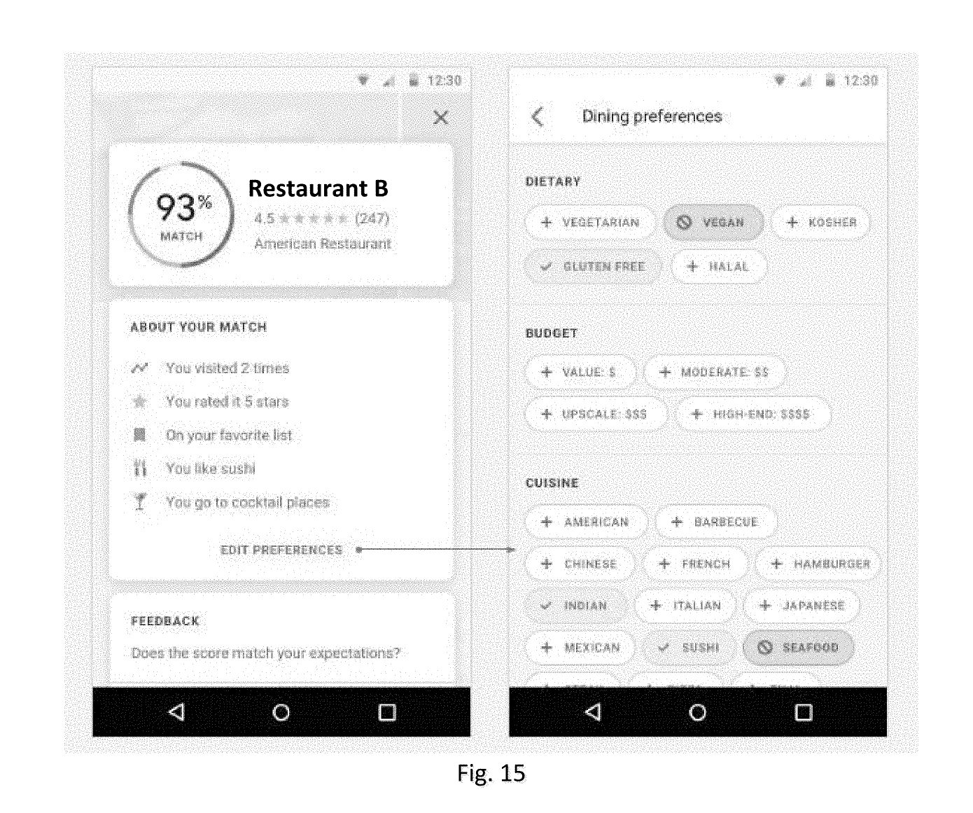

FIG. 15 illustrates an example relationship between the score detail page and the preference editing section. In this example, the score detail page provides a link to edit the user preferences. Interacting with the link brings the user to the preference editing section, where the user may change indications as to whether they have a positive or negative preference for any particular option.

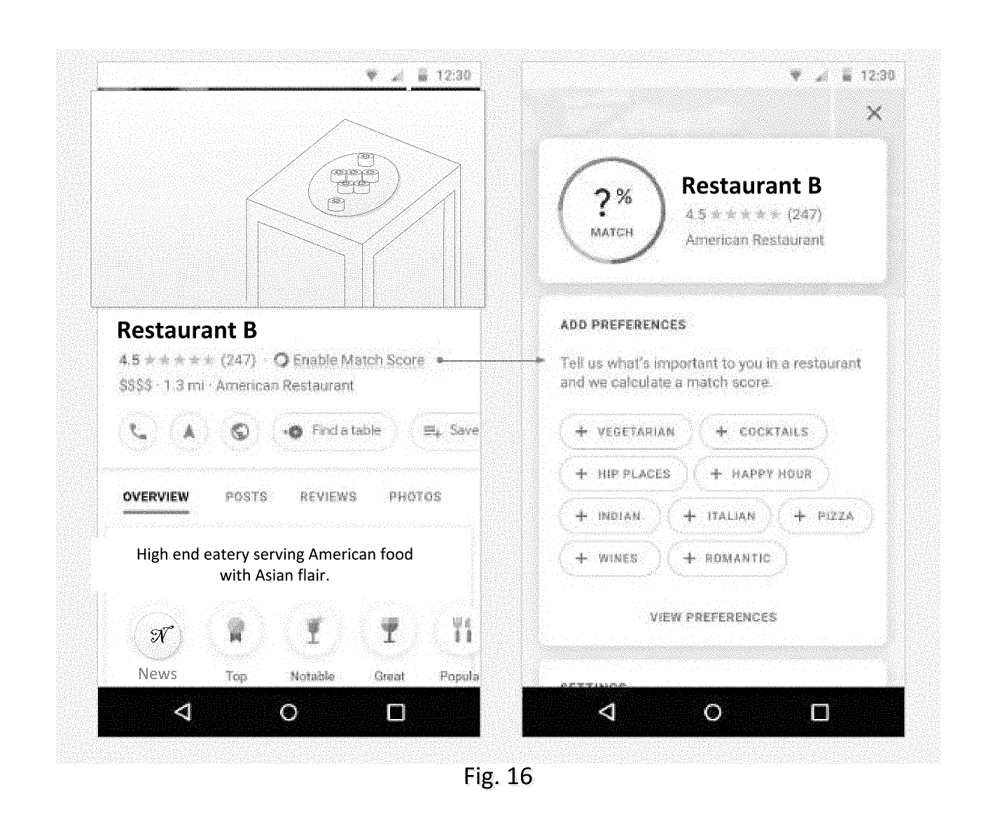

FIG. 16 illustrates an example information page that may be presented to the user when personal score matching is first enabled. For example, similar to FIG. 12, further information regarding the user's preferences may be required in order to generate a personal score. Accordingly, the user is presented with the information page. The information page may seek the user's input as to what types are features are important to the user when selecting a restaurant or other point of interest. In some examples, a variety of options may be presented as shortcuts, such as cocktails, pizza, romantic, etc. Also presented is a link to the full preference editing section.

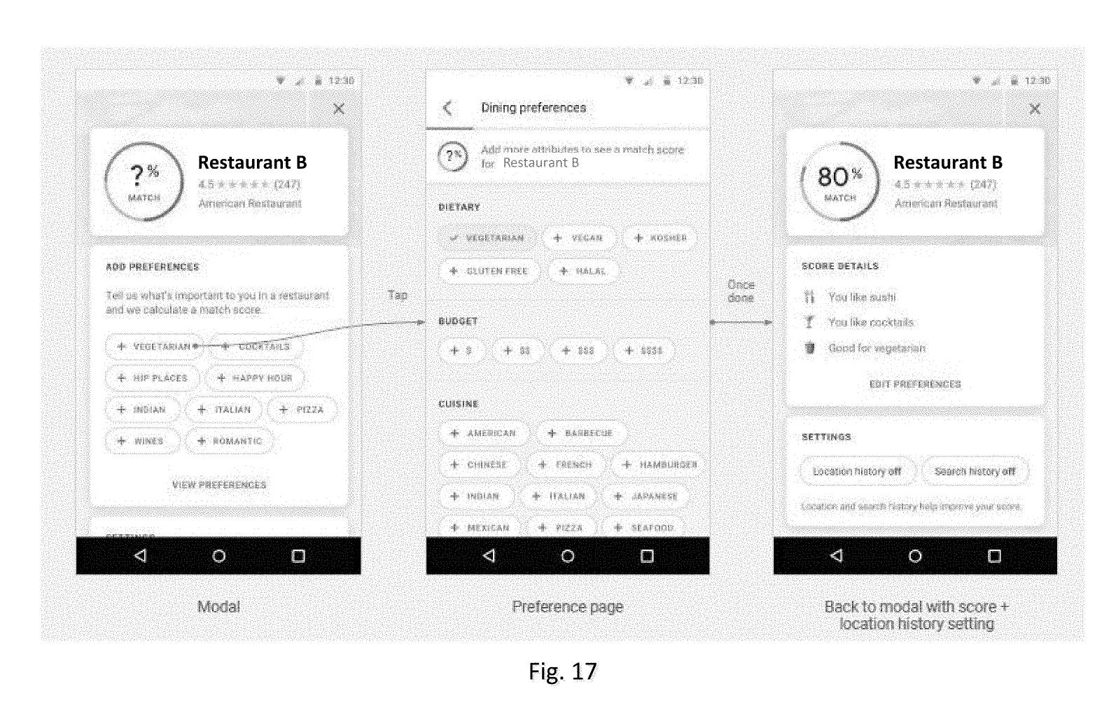

FIG. 17 illustrates an example interaction with one of the shortcut buttons of FIG. 16. For example, if the user clicks the “vegetarian” shortcut button, the user may be taken to a preference page. On the preference page, the vegetarian option is updated to be a positive preference, and as such is represented using a positive indicator. Further categories, in addition to the dietary category, are also presented. In this example, such further categories include budget, cuisine, and more if the user scrolls further down. Each of these categories includes a variety of options which may be selected by the user to indicate a positive or negative preference. Once the user indicates preferences on the preference page, the user may be taken to an updated information page. The updated information page includes a match score, here 80%, based on the preferences indicated by the user on the preference page.

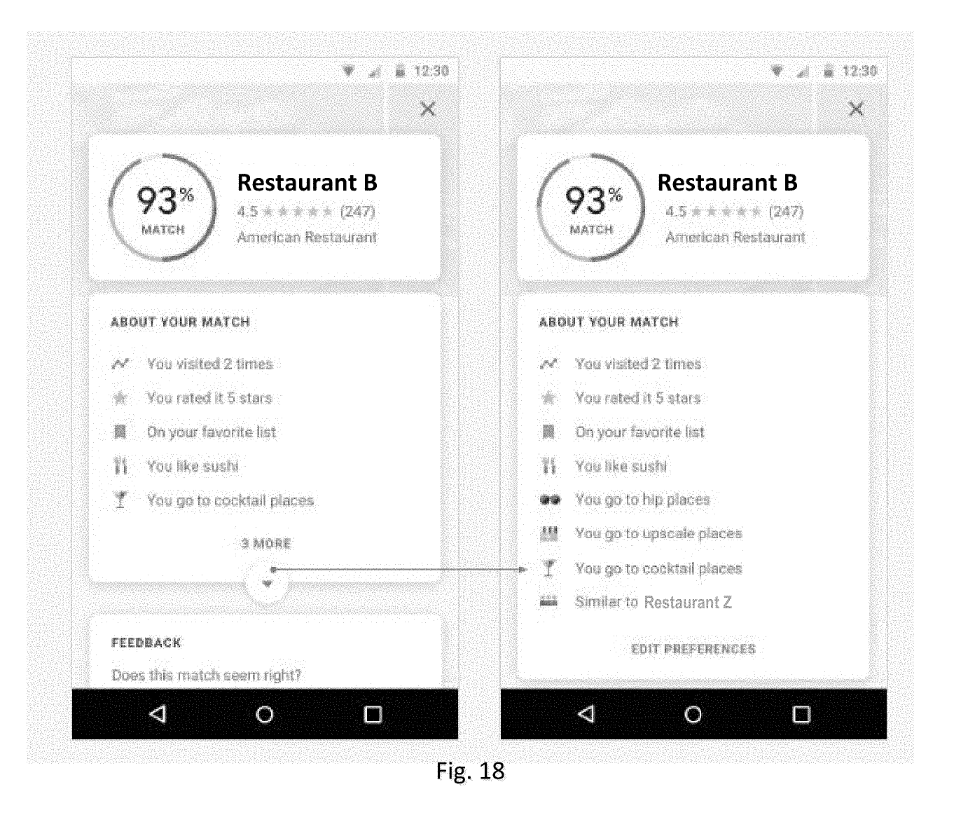

FIG. 18 illustrates an example interface for the place detail page, where one or more sections may be expanded to view further information. For example, if the section explaining the basis for the match score includes a number of factors, the listing of factors may be condensed by hiding one or more factors, such as the factors of lower importance. If the user is interested to see such additional factors, the user may interact with a portion of the screen, such as the arrow button or the linked text “3 MORE” or any other type of link not shown. Upon such interaction, the list may be expanded to make visible the previously hidden factors.

As mentioned above in connection with FIG. 14, a place detail page may include a section requesting feedback from the user. FIG. 19 illustrates an example of the requested feedback. In this example, the user is asked whether the personal score seems right. For example, the user may view information about Restaurant B, such as the summary information, other user reviews, a website for Restaurant B, the menu, or any other information available from any number of sources. The user may also visit Restaurant B and try dining there. The user may then determine whether the personal score is approximately the same as the user's own assessment of Restaurant B. If the user determines that the personal score is accurate, the user may click “yes.” Such feedback may be used to confirm and strengthen the machine learning model used to compute the score. As shown in FIG. 19, it may also be used to suggest similar places to Restaurant B that the user might also enjoy.

FIG. 20 illustrates an example where the user indicates in the feedback section that the personal score does not seem accurate. To determine a more accurate score, the user may be asked for additional feedback. By way of example, the user may be asked to update the user preferences. The user may additionally or alternatively be given an option to authorize automatic reporting. Other types of feedback are also possible, such as comments, etc. The additional feedback may be used to generate an updated personal score for the user.

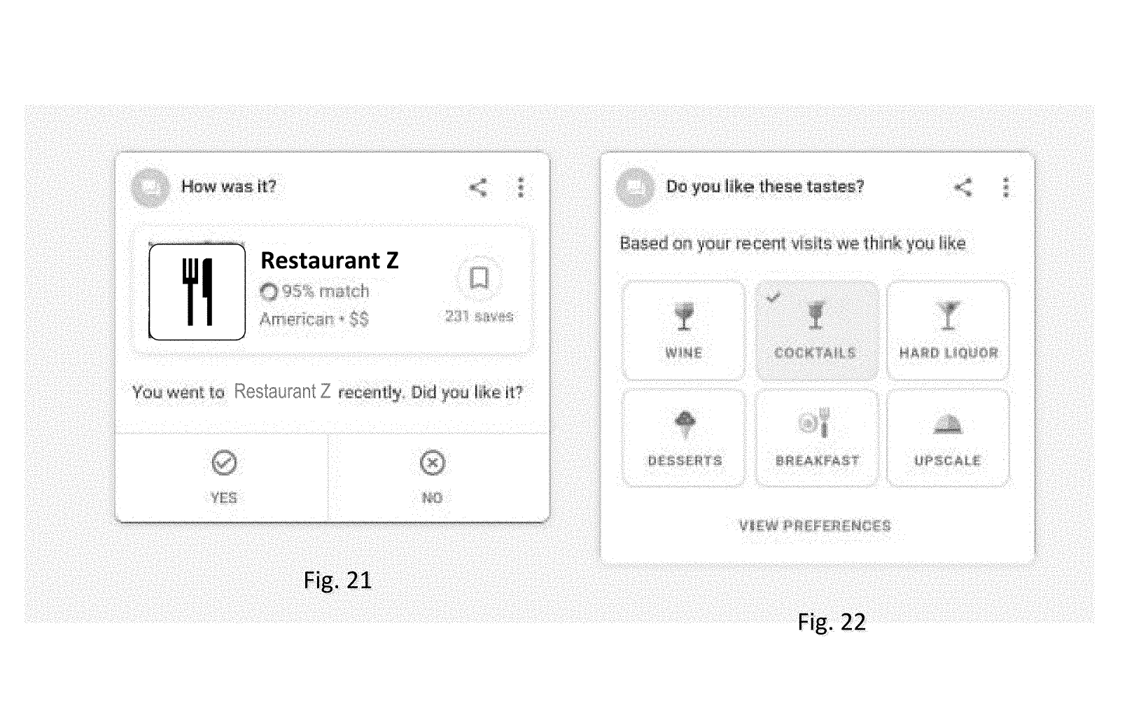

Another type of feedback includes surveys. FIGS. 21-22 illustrate examples of surveys which may be provided to the user. In FIG. 21, the survey is based on the user's actual visit to the place. For example, if the user has authorized location reporting, the survey may be presented to the user after determining that the user's device visited a location matching the place. The survey may present one or more questions, such as asking whether the user liked the place. The user can respond in any of a number of ways, including selecting a response button or interacting with the survey using other features, not shown.

In FIG. 22, the survey requests confirmation for predictions made based on the user's activity. For example, for a user activity of visiting a particular place, the model may infer that the user enjoys particular options, such as cocktails. The user may be asked to confirm this inference, or to update the user's preferences if such inference is incorrect.

### Example Methods:

Further to the example systems described above, example methods are now described. Such methods may be performed using the systems described above, modifications thereof, or any of a variety of systems having different configurations. It should be understood that the operations involved in the following methods need not be performed in the precise order described. Rather, various operations may be handled in a different order or simultaneously, and operations may be added or omitted.

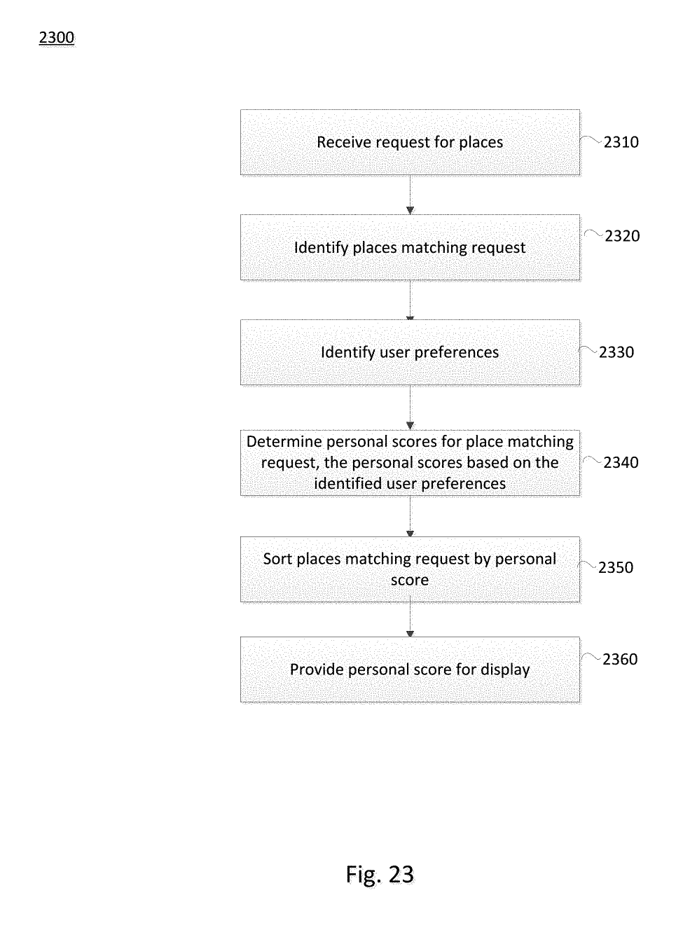

FIG. 23 provides a flow diagram illustrating a method 2300 of providing a personal score for a place. In block 2310, a request for places is received. The request may be, for example, a search entered through a search engine, map application, or any other type of website, application, or the like. The place may be requested using various types of information, such as name, address, category, general location, etc. For example, the request may specify “gas stations near me” or “things to do in Springfield” or any other such information. The requested place may be any number of different types of places, such as restaurants, stores, banks, gas stations, fitness centers, museums, etc.

In block 2320, places matching the request are identified. By way of example, all places within a predetermined geographical range may be identified as candidates for recommendations to the user. In some examples, the places identified as matching the request may be indicated to the user on a map or in any other form.

In block 2330, user preferences are identified. The user preferences may be relevant to the type of place requested. For example, if the type of place requested is a place to eat food, the identified user preferences may relate to cuisine, budget, ambiance etc. If the type of place requested is a clothing store, the user preferences may relate to budget, style, etc. The user preferences may be identified from a larger set of user preferences that are stored. For example, if a user authorizes location reporting or web history reporting, the user preferences may include inferences based on locations or websites previously visited by the user. The user preferences may also include explicit preferences entered by the user. Such explicit preferences may be entered at any time before or after the request is entered. In some examples, the user preferences may also include restrictions. For example, if a user cannot go to a particular type of restaurant because of a food allergy, such food allergy may be identified as a restriction. Various other types of restrictions are also possible.

In block 2340, a personal score is generated for one or more of the places matching the request. The personal score is specific to the user, generated based on the identified user preferences. The personal score may be generated using a machine learning model, such as described above in connection with FIGS. 7-10.

In block 2350, places matching the request may optionally be sorted by the personal score. For example, the results may be sorted from highest personal score to lowest. In some examples, the sort may be based on a plurality of factors, such as personal score in combination with location. Further, matches violating a restriction may be filtered out of the results.

In block 2360, the personal scores are provided for display, such as by transmitting to the user's device. For example, the personal score for a particular result may be provided in association with other information about the particular result.

It should be understood that the method described above is merely an example, and that other methods may also be implemented. For example, recommendations may be actively sent to a user, without receiving a request from the user. For example, periodic (e.g., weekly) suggestions may be sent to the user based on places with high personal scores in areas of interest to the user.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for providing a personal score for a place, the method comprising:
identifying, with one or more processors, one or more places of potential interest to a user;
identifying, with the one or more processors, user preferences;
determining, with the one or more processors, a personal score for one or more of the places, the personal score being generated based on the identified user preferences; and
providing for display, with the one or more processors, the personal score for the one or more of the places in association with information about the place.

2. The method of claim 1, further comprising:
receiving a request;
matching the one or more places of potential interest to the request; and
sorting the places matching the request based on the personal scores.

3. The method of claim 1, wherein the user preferences include explicit preferences entered by the user through a user interface.

4. The method of claim 1, wherein the user preferences include implicit preferences inferred by information passively collected from the user with the user's authorization.

5. The method of claim 1, wherein determining the personal score comprises applying a machine learning model.

6. The method of claim 1, further comprising:
determining a set of explanations for the determined personal score, and
providing the explanations for display with the personal score.

7. The method of claim 6, wherein the set of explanations indicate reasons the user may like the one or more places.

8. The method of claim 6, wherein the set of explanations is generated based on the identified user preferences and information about the one or more places.

9. A system for providing a personal score for a place, comprising:
one or more memories storing preferences of the user;
one or more processors in communication with the one or more memories, the one or more processors configured to:
receive a request for a place;
identify one or more places matching the request;
identify user preferences;
determine a personal score for one or more of the place matching the request, the personal score being generated based on the identified user preferences; and
provide for display the personal score for the one or more of the place matching the request in association with information about the place matching the request.

10. The system of claim 9, wherein the one or more processors is further configured to sort the places matching the request based on the personal scores.

11. The system of claim 9, wherein the user preferences include explicit preferences entered by the user through a user interface.

12. The system of claim 9, wherein the user preferences include implicit preferences inferred by information passively collected from the user with the user's authorization.

13. The system of claim 9, wherein determining the personal score comprises applying a machine learning model.

14. The system of claim 9, wherein the one or more processors is further configured to generate a set of explanations for the determined score and provide the set of explanations for display.

15. A method for constructing a machine learning model to generate a personal score for a place, the personal score based on preferences of a given user, the method comprising:
accessing data from multiple sources,
generating, using the accessed data, a user table including user visit data and online place interactions;
generating, using the accessed data, a place table including an identification of places matching a particular set of criteria and place-level attributes used for identifying preferences;
creating a lookup table associating a user identifier to samples of places, the samples being places for which the user has indicated interest or disinterest;
joining the lookup table to the user table; and
training a model to predict a personal score for any given place using the joined tables.

16. The method of claim 15, further comprising:
computing a personal score using the model;
receiving survey results relating to an accuracy of the computed personal score; and
modifying the model based on the survey results.

17. The method of claim 15, wherein the model is one of a linear classification model, a linear regression model, or an ordinal regression model.

18. The method of claim 15, wherein training data for the model includes positive and negative factors.

19. The method of claim 18, wherein:
the positive factors relate to at least one of a user's previous visits to a place or a user's previous online interactions with the place; and
the negative factors relate to places a user had not previously visited nor interacted with, or a place for which the user has indicated a negative preference.

20. The method of claim 15, wherein signals for the model may include both personalized and contextual signals.
